(19) United States
(12) Patent Application Publication
(10) Pub. No.: US 2026/0008444 A1
(43) Pub. Date: Jan. 8, 2026

(54) COMPRESSED AIR DISTRIBUTION SYSTEMS, VEHICLES AND GROUP OF VEHICLES

(71) Applicant: Faiveley Transport Italia S.P.A., Piossasco (Torino) (IT)

(72) Inventors: Matteo FREA, Piossasco (Torino) (IT); Jean-Philippe BOUTEILLE, Le Plessis-Brion (IT)

(73) Assignee: Faiveley Transport Italia S.P.A., Piossasco (Torino) (IT)

(21) Appl. No.: 19/260,089

(22) Filed: Jul. 3, 2025

(30) Foreign Application Priority Data
Jul. 5, 2024 (IT) 102024000015568

(51) Int. Cl. B60T 13/36; B60T 13/26; B60T 17/02

(52) U.S. Cl. CPC B60T 13/365; B60T 13/268; B60T 17/02

(57) ABSTRACT

A compressed air distribution system for a vehicle (e.g., rail vehicle) includes first and second reservoirs and first and second compressors. The first and second reservoirs are configured to contain respective compressed air to be supplied to first and second braking systems of the vehicle. The first braking system is configured to apply a first braking force to a first wheel set of the vehicle with the compressed air received from the first reservoir, and the second braking system is configured to apply a second braking force to a second wheel set with the compressed air received from the second reservoir. Each wheel set includes a respective axle and a respective one or more wheels coupled to the axle. The first and second compressors are configured to generate compressed air to be stored in the first and second reservoirs, respectively.

### CROSS-REFERENCE TO RELATED APPLICATION

This application claims benefit of and priority to Italian Patent Application No. 102024000015568, titled “COMPRESSED AIR DISTRIBUTION SYSTEMS, VEHICLES AND GROUP OF VEHICLES,” filed Jul. 5, 2024, the entire disclosure of which is hereby incorporated by reference herein.

### BACKGROUND

### Technical Field

Aspects of the invention relate to vehicles. Other aspects relate to compressed air distribution systems for rail vehicles.

### Discussion of Art

Hereinafter, the prior art is described with particular reference to the field of rail vehicles, however, what is described can also find similar application for vehicles of other sectors.

As illustrated for example in FIG. 1, rail vehicles (e.g., vehicles that travel along a track having two or more parallel rails) can be connected to one another to form a rail vehicle convoy or consist, e.g., a train. Each rail vehicle can be a locomotive (for example, a vehicle having an engine and/or traction motors, which may be positioned at the head or end of the convoy) or an intermediate/following vehicle connected to the locomotive and adapted to be moved by the locomotive. A rail vehicle convoy can also include more than one locomotive and more than one intermediate/following vehicle.

Many rail vehicle braking systems operate using compressed air. A system for generating compressed air for a train or other rail vehicle convoy according to the prior art is illustrated in FIG. 1. The system for generating compressed air of the locomotive includes a compressor 102 configured to draw in air at atmospheric pressure, compress it, and, through a pneumatic connection, supply the compressed air to a main reservoir 100 of the locomotive adapted to contain a predetermined volume of compressed air.

Through a distribution pipe P, the compressed air stored in the reservoir 100 can be supplied to at least one pneumatic system, such as for example, the braking system, a pneumatic suspension system, pneumatically operated toilets, a pneumatically actuated pantograph, or pneumatically controlled doors of the locomotive and/or of any further following/intermediate vehicles connected to the locomotive by the distribution pipe. (E.g., each vehicle in a convoy may include a respective onboard section of the distribution pipe, which is pneumatically connected to adjacent vehicles via flexible hose couplings or pipe couplings.)

Disadvantageously, since the reservoir 100 must contain a predetermined volume of air sufficient to serve all the vehicles in a convoy (locomotive and any further following/intermediate vehicles connected to it), the size of the reservoir 100 is typically large. Additionally, in certain conditions it may be required to accumulate in the reservoir the quantity of air in a reduced unit of time. Because the size of the reservoir 100 is large, the power and the size of the compressor 102 of the locomotive must also be large. In other words, in order to have the quantity of compressed air, in the unit of time, required by the system in certain conditions (start-up of the train in the morning, refilling reservoirs after braking or emergency double braking, etc.), the compressor must have an extremely high flow rate, which makes it inefficient in other standard operating situations where the use is reduced. This aspect may negatively affect the reliability and wear of the system.

Moreover, it is known that compressors suitably sized for such applications of compressed air generation are a source of high vibrations and high noise. Disadvantageously, such noise can be perceived in the surrounding environment, for example in large stations with many passengers, stations located in inhabited centres, etc.

A further drawback of known solutions, which comprise a main reservoir and the compressor 102 only in the locomotive, concerns the use of long pipes to convey the compressed air between the reservoir and the various recipient systems of the compressed air installed in the various vehicles of the convoy (locomotive and following/intermediate vehicles connected to it). Pneumatically connecting all the rial vehicles in a long convoy requires multiple pipe crossings between the various vehicles, which adds to cost and operational complexity for possible failure modes.

It may be desirable to provide a compressed air distribution system for a vehicle, which differs from existing systems.

### BRIEF DESCRIPTION

In an embodiment, a compressed air distribution system for a vehicle includes a first reservoir, a second reservoir, a first compressor, and a second compressor. The first reservoir is configured to contain compressed air to be supplied to a first braking system of the vehicle. The first braking system is configured to apply a first braking force to a first wheel set of the vehicle with the compressed air received from the first reservoir. The first wheel set includes a first axle and at least one first wheel coupled to the first axle. The second reservoir is configured to contain compressed air to be supplied to a second braking system of the vehicle, wherein the second braking system is configured to apply a second braking force to a second wheel set with the compressed air received from the second reservoir. The second wheel set includes a second axle and at least one second wheel coupled to the second axle. The first compressor is configured to generate compressed air to be stored in the first reservoir, and the second compressor is configured to generate compressed air to be stored in the second reservoir.

In an embodiment, a vehicle includes a first bogie, a second bogie, a first braking system, a second braking system, and a compressed air distribution system. The first bogie includes a plurality of first wheel sets, and the second bogie includes a plurality of second wheel sets. Each of the first and second wheel sets includes a respective axle and one or more respective wheels coupled to respective axle. The first braking system is configured to apply a first braking force on the first wheel sets, and the second braking system is configured to apply a second braking force on the second wheel sets. The compressed air distribution system includes a first reservoir, a second reservoir, a first compressor, and a second compressor. The first reservoir is configured to contain compressed air to be supplied to the first braking system; the first braking system is configured to apply the first braking force with the compressed air received from the first reservoir. The second reservoir is configured to contain compressed air to be supplied to the second braking system; the second braking system is configured to apply the second braking force with the compressed air received from the second reservoir. The first compressor is configured to generate compressed air to be stored in the first reservoir, and the second compressor is configured to generate compressed air to be stored in the second reservoir.

In an embodiment, a compressed air distribution system for a vehicle includes at least one air generation treatment unit configured to treat air solely intended for a braking system of the vehicle and/or at least one pneumatic system of the vehicle. The system also includes a reservoir configured to contain compressed air to be supplied to the at least one air generation treatment unit of the vehicle, and at least one first compressor configured to generate compressed air to be stored in the reservoir.

### BRIEF DESCRIPTION OF THE DRAWINGS

Reference is made to the accompanying drawings, in which:

FIG. 1 illustrates a system for generating compressed air according to the prior art;

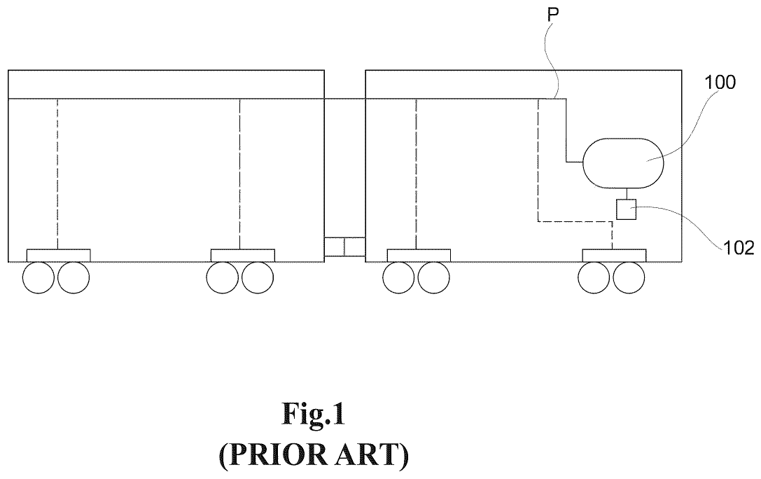

FIG. 2 illustrates a vehicle with a compressed air distribution system, according to one embodiment of the invention;

FIG. 3 illustrates another embodiment of a vehicle with a compressed air distribution system;

FIG. 4 illustrates another embodiment of a vehicle with a compressed air distribution system;

FIG. 5 illustrates another embodiment of a vehicle with a compressed air distribution system; and

FIG. 6 illustrates another embodiment of a vehicle with a compressed air distribution system.

### DETAILED DESCRIPTION

In an embodiment, a compressed air distribution system for a vehicle (e.g., a rail vehicle) includes a first reservoir, a second reservoir, a first compressor, and a second compressor. The first reservoir is configured to contain compressed air to be supplied to a first braking system of the vehicle. The first braking system is configured to apply a first braking force to a first wheel set of the vehicle with the compressed air received from the first reservoir. The first wheel set includes a first axle and at least one first wheel, e.g., two first wheels, coupled to the first axle. The second reservoir is configured to contain compressed air to be supplied to a second braking system of the vehicle. The second braking system is configured to apply a second braking force to a second wheel set with the compressed air received from the second reservoir. The second wheel set includes a second axle and at least one second wheel coupled to the second axle. The first compressor is configured to generate compressed air to be stored in the first reservoir, and the second compressor is configured to generate compressed air to be stored in the second reservoir.

Each braking system may include plural braking system components, such as pneumatic cylinders, brake callipers configured to be driven by the pneumatic cylinders, and brake pads, brake shoes, or other friction members connected to the brake callipers. In operation, pneumatic controls (or other controls) cause the pneumatic cylinders to actuate the brake callipers, which under pneumatic power from the compressed air in a reservoir, cause the friction members to press against a wheel, axle, or a brake disc, brake drum, or other brake member attached to a wheel or axle. This causes the vehicle to slow (and potentially eventually stop), with kinetic energy dissipated as heat between the frictional members and axle, wheel, or brake member.

According to one aspect, the vehicle may be configured to be pneumatically connected to adjacent vehicles (including indirectly or directly to a locomotive), such that the vehicle receives compressed air from an off-board reservoir (e.g., from the main reservoir and compressor of a locomotive), for service and emergency braking purposes. (Train service braking refers to the normal braking used during regular train operations for slowing down and stopping. It is distinct from emergency braking, which is used in designated critical situations to stop the train as quickly as possible.) In such an embodiment, however, due to the presence of the first and second reservoirs onboard the vehicle, the off-board reservoir and compressor may be sized smaller than if they were the only reservoir and compressor designated for use in a designated size range (max number of connected vehicles) of vehicle convoy. Or, the compressor may be the same size, but operated at a lighter duty cycle than if it was the only compressor for a vehicle convoy.

According to another aspect, the vehicle may be configured to be pneumatically connected to adjacent vehicles (including indirectly or directly to a locomotive), such that the vehicle receives compressed air from an off-board reservoir (e.g., from the main reservoir and compressor of a locomotive), for emergency braking purposes only and not for service braking. Here, the first and second reservoirs onboard the vehicle would be used for service braking, whereas emergency braking of the vehicle would be initiated and/or powered from compressed air received from offboard.

According to another aspect, the vehicle may be (i) not pneumatically connected to any adjacent vehicles, and/or (ii) not configured to be pneumatically connected to adjacent vehicles. In the former, the vehicle could be configured for possible such connection, but in use in a particular convoy is not actually so connected. In the latter, the vehicle cannot be pneumatically coupled to adjacent vehicles, e.g., for braking. In such an embodiment, service braking of the vehicle would be carried out using the onboard first and second reservoirs, etc., and not using compressed air received from offboard. In such an embodiment, the vehicle could also include an emergency braking system onboard the vehicle which is configured to brake the vehicle responsive to receipt of a designated emergency braking signal. For example, the emergency braking system could include an electrical trainline extending between adjacent vehicles of a convoy, such that if the trainline breaks the emergency braking system would initiate an emergency braking operation, e.g., responsive to a zero or decreased voltage on the trainline, using pneumatics from the first and second reservoirs, etc., or otherwise. As another example, the emergency braking system could include a wireless transceiver, with the emergency braking system being configured to initiate an emergency braking operation (e.g., using pneumatics from the first and second reservoirs, etc., or otherwise) upon receipt of a designated signal over a wireless link. (The designated signal could be a received waveform transitioning to no received waveform, for example.) As an example, signals could be generated onboard a locomotive responsive to sensor information, e.g., if a distance between a head-of-train device and an end-of-train device increases over a threshold indicative of a train brake, an emergency braking operation would be initiated. In any such embodiments, the emergency braking system may be configured as a vital system, meaning failure states result in initiation of an emergency braking operation or reversion to another safe state. An onboard emergency braking system could also be configured to initiate an emergency braking operation responsive to faults in the onboard compressors and/or onboard reservoirs. For example, the onboard emergency braking system could include brake cylinders, brake shoes/pads, etc. that are normally deactivated when pressure in one of the onboard reservoirs is above a designated level, but which are automatically activated when the pressure goes below the designated level by a designated threshold or otherwise.

According to one aspect, whereas braking control signals may be pneumatically propagated in rail vehicle convoys that have a brake pipe interconnecting the vehicles in the convoy, if the vehicles in a convoy are not so connected (i.e., not pneumatically connected), a vehicle may include a control circuit to initiate braking, using the compressed air in the onboard two or more reservoirs, responsive to designated criteria and not including receipt of pneumatic signals over a brake pipe. (Or there may be (i) pneumatic control of emergency braking, but non-pneumatic control of service braking, or (ii) pneumatic control of both emergency and service braking based on pneumatic signals received from offboard the vehicle over a brake pipe, but with additional local control to supplement braking based on the brake pipe compressed air, e.g., to reduce the duty cycle of an offboard compressor on a locomotive.) Embodiments might include local/onboard control, control based on signals received from offboard the vehicle over an electrical trainline interconnecting the vehicles of a convoy, and/or control based on signals received from offboard the vehicle wirelessly over a wireless link, e.g., such signals generated by a locomotive control system, a back office or other remote control system, a wayside control system, or the like. Thus, in embodiments, a vehicle may include a control circuit that is configured to cause the first and second braking systems to be actuated for braking the vehicle responsive to one or more designated criteria. The criteria may include one or more of: (i) received sensor information containing designated information (e.g., of vehicle operation, surrounding conditions, convoy operations, etc.); (ii) wireless receipt of designated control signals from offboard the vehicle; (iii) receipt of designated control signals from offboard the vehicle over an electrical trainline that electrically connects the vehicle with other vehicles in a rail vehicle convoy; (iv) onboard operator controls; (v) receipt of pneumatic control signals from offboard the vehicle; etc.

In an embodiment, a rail vehicle may be configured to be pneumatically connected to a rail vehicle convoy (train) brake pipe, for both service and emergency braking based on pneumatic signals received over the brake pipe. The rail vehicle includes a compressed air distribution system as described herein, which is configured for the reservoirs, compressors, etc. to supplement compressed air received over the brake pipe, e.g., to repressurize brake cylinders of the vehicle after a braking operation, compressed air may be at least partially supplied by the reservoirs onboard the vehicle. In such an embodiment, the main reservoir of a locomotive would be required to provide less compressed air for the brake pipe, allowing for a reduced compressor duty cycle and/or provision of a smaller capacity locomotive main compressor.

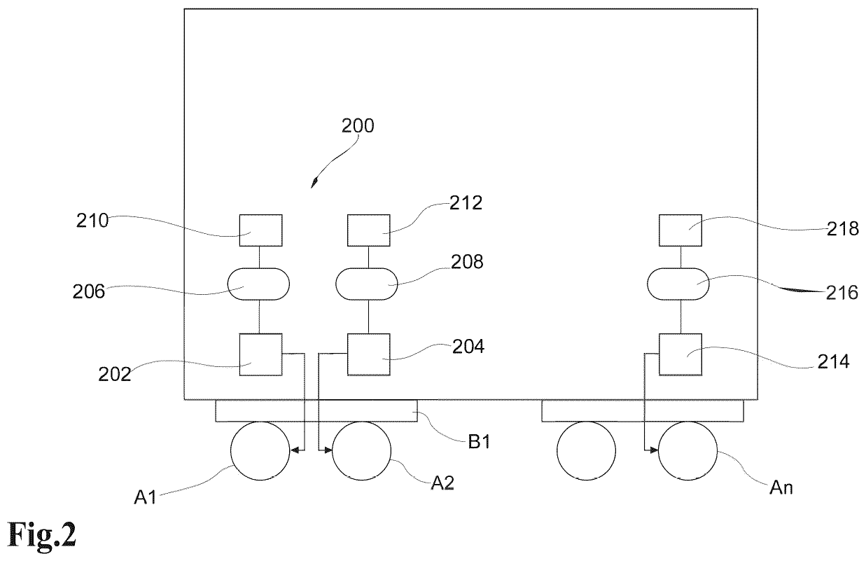

FIG. 2 illustrates a first embodiment of a compressed air distribution system for a vehicle, e.g., a rail vehicle. As shown in FIG. 2, the vehicle includes at least a first wheel set A1 having a first axle to which at least one first wheel is coupled and a second wheel set A2 having a second axle to which at least one second wheel is coupled. The vehicle further includes a first braking system 202 configured to apply a first braking force on the first wheel set A1, e.g., on the first axle, or on the at least one first wheel coupled to the first axle, or on a first braking member coupled to the first axle or coupled to the at least one first wheel coupled to the first axle A1. The vehicle further includes a second braking system 204 configured to apply a second braking force on the second wheel set A2, e.g., on the second axle, on the at least one second wheel coupled to the second axle, or on a second braking member coupled to the second axle or coupled to the at least one second wheel coupled to the second axle.

By way of example, the first braking member and/or the second braking member may each comprise a brake disc or brake drum configured to be coupled to an axle or to a wheel.

As shown in FIG. 2, the vehicle also includes a compressed air distribution system 200 that includes, at least, a first reservoir 206 configured to contain compressed air to be supplied to the first braking system 202, and a second reservoir 208 configured to contain compressed air to be supplied to the second braking system 204. In this embodiment, the first braking system is configured to apply the first braking force by means of the compressed air received from the first reservoir 206 and the second braking system is configured to apply the second braking force by means of the compressed air received from the second reservoir 208.

By way of non-limiting example, the first braking system and the second braking system may respectively include at least one brake cylinder configured to receive compressed air, at least one compressed air control valve, and/or at least one braking application device. For example, the braking application device may include one or more brake shoes, brake pads, levers or rods, callipers, etc.

As also shown in FIG. 2, the compressed air distribution system 200 also includes a first compressor 210 configured to generate compressed air to be stored in the first reservoir 206, and a second compressor 212 configured to generate compressed air to be stored in the second reservoir 208. The compressors may be electrically powered with electricity received over a trainline, with electricity received from an onboard generator, with electricity received from onboard energy storage devices, etc.

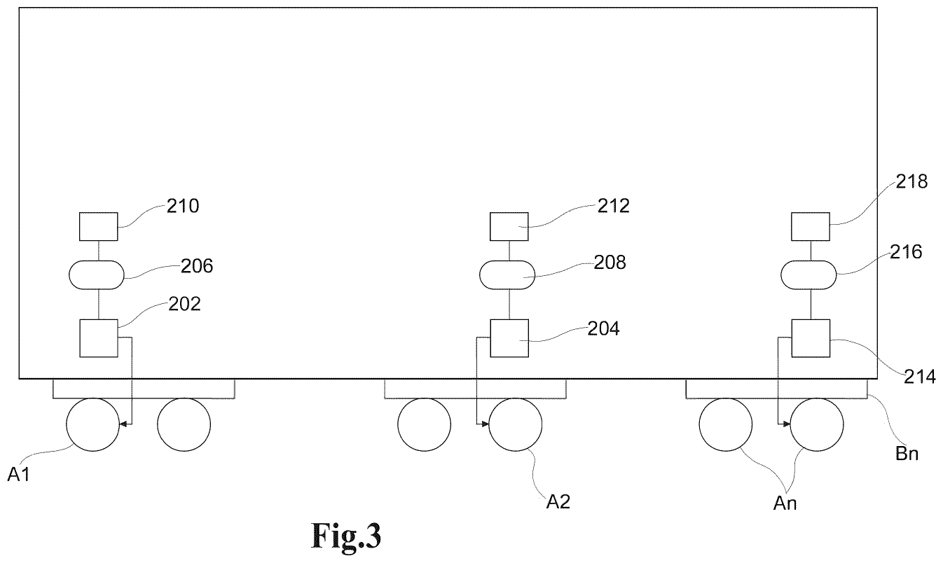

As shown in FIG. 2, in an embodiment, the first wheel set A1 may be operably coupled to a first bogie B1 of the vehicle and the second wheel set A2 may also be operably coupled to the first bogie B1 of the vehicle. In an alternative embodiment, as shown for example in FIG. 3, the first wheel set A1 may be operably coupled to a first bogie B1 of the vehicle and the second wheel set A2 may be operably coupled to a second bogie B2 of the vehicle.

As observable for example in FIG. 2 and in FIG. 3, the vehicle may comprise, in addition to the first wheel set A1 and the second wheel set A2, at least one further wheel set An each having a respective further axle to which at least one respective further wheel is coupled. For each further wheel set An, the vehicle may include respective further braking systems 214 configured to apply a further braking force on a respective further wheel set An, e.g., on an axle, wheel, or braking member of the respective further wheel set. In this case, the compressed air distribution system 200 may include, for each respective further wheel set An, a respective further reservoir 216 configured to contain compressed air to be supplied to the respective further braking system 214 configured to apply the further braking force by means of the compressed air received from the respective further reservoir 216, and a respective further compressor 218 configured to generate compressed air to be stored in the respective further reservoir 216.

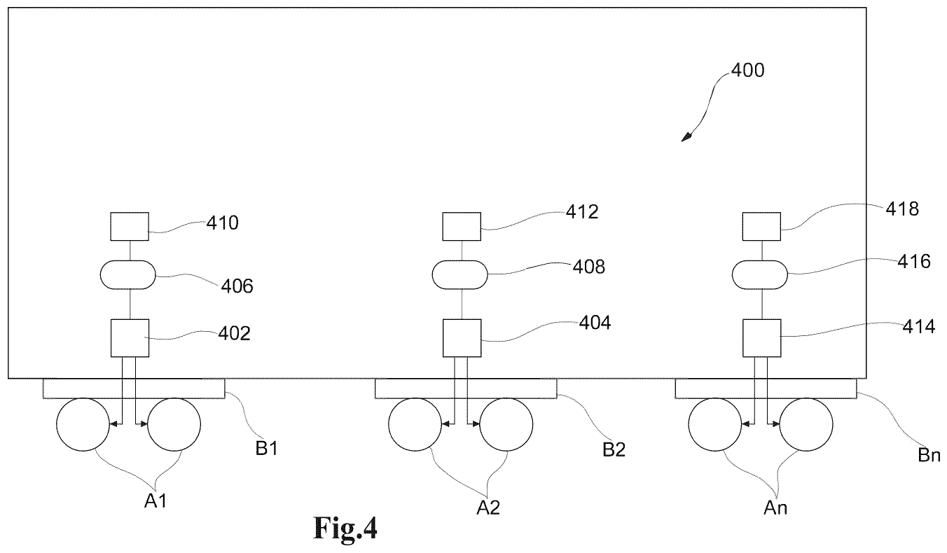

Hereinafter, with exemplary reference to FIG. 4, a further embodiment of a compressed air distribution system 400 for a vehicle, e.g. a rail vehicle, is illustrated.

As shown in FIG. 4, the vehicle includes at least a first bogie B1 having a plurality of first wheel sets A1 (each having a respective first axle to which respective first wheels are coupled) and a second bogie B2 having a plurality of second wheel sets A2 (each having a respective second axle to which respective second wheels are coupled). The vehicle also includes a first braking system 402 configured to apply a first braking force on the plurality of first wheel sets A1 of the first bogie B1 (e.g., to the axles, wheels, or braking members of the first wheel sets A1 of the first bogie B1), and a second braking system 404 configured to apply a second braking force on the plurality of second wheel sets A2 of the second bogie B2 (e.g., to the axles, wheels, or braking members of the second wheel sets A2 of the second bogie B2).

As shown in FIG. 4, the compressed air distribution system 400 includes at least a first reservoir 406 configured to contain compressed air to be supplied to the first braking system 402, and a second reservoir 408 configured to contain compressed air to be supplied to the second braking system 404. In this case, the first braking system 402 is configured to apply the first braking force with the compressed air received from the first reservoir 406 and the second braking system 404 is configured to apply the second braking force with the compressed air received from the second reservoir 408.

The compressed air distribution system 400 further includes at least a first compressor 410 configured to generate compressed air to be stored in the first reservoir 406 and a second compressor 412 configured to generate compressed air to be stored in the second reservoir 408.

As shown again in FIG. 4, the vehicle may include, in addition to the first bogie B1 and the second bogie B2, at least one further bogie Bn having a plurality of further wheel sets An (each having a respective axle and wheels). For each further bogie Bn, the vehicle may include a respective further braking system 414 configured to apply a respective further braking force on the plurality of further wheel sets An of a respective further bogie Bn (e.g., the further braking force applied to an axle, wheel, or braking member attached to a wheel or axle). In this case, the compressed air distribution system 400 may include, for each respective further bogie Bn, at least one respective further reservoir 416 configured to contain compressed air to be supplied to the respective further braking system 414 configured to apply the respective further braking force by means of the compressed air received from the respective further reservoir 416, and a respective further compressor 418 configured to generate compressed air to be stored in the at least one respective further reservoir 416.

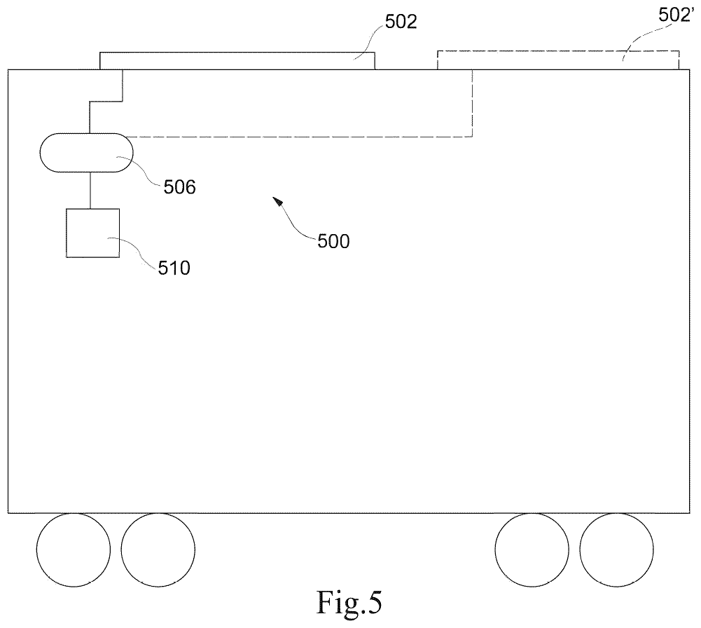

FIG. 5 shows a further embodiment of a compressed air distribution system 500 for a vehicle, e.g., a rail vehicle. In this embodiment, the system 500 includes at least one air generation treatment unit 502, AGTU (also known as “Air Generation Treatment Unit”), configured to treat air solely intended for a braking system of the vehicle and/or at least one pneumatic system of the vehicle, a reservoir 506 configured to contain compressed air to be supplied to the air generation treatment unit of the vehicle, and at least one first compressor 510 configured to generate compressed air to be stored in the reservoir 506.

In embodiments, the compressed air distribution system 500 may include at least one second compressor configured to generate compressed air to be stored in the reservoir (506).

The pneumatic system of the vehicle may be at least one of: an opening and closing system of at least one door of the vehicle; a pneumatic suspension system of the vehicle; a toilet system of the vehicle; and/or a handling system of at least one pantograph of the vehicle (e.g., to raise and lower and/or otherwise control the pantograph).

In embodiments, the vehicle may include a plurality of air generation treatment units 502, 502′ configured to treat air solely intended for a braking system of the vehicle and/or at least one pneumatic system of the vehicle. In this case, the reservoir 506 may be configured to contain compressed air to be supplied to the plurality of air generation treatment units of the vehicle.

Because the air generation treatment unit 502 is configured to treat air solely intended for a braking system of the vehicle and/or at least one pneumatic system of the vehicle, the size of the air generation treatment unit 502 may be smaller than the air generation treatment unit used in some vehicle convoys, which is configured to treat compressed air also for all the possible vehicles of the group of vehicles/convoy of vehicles.

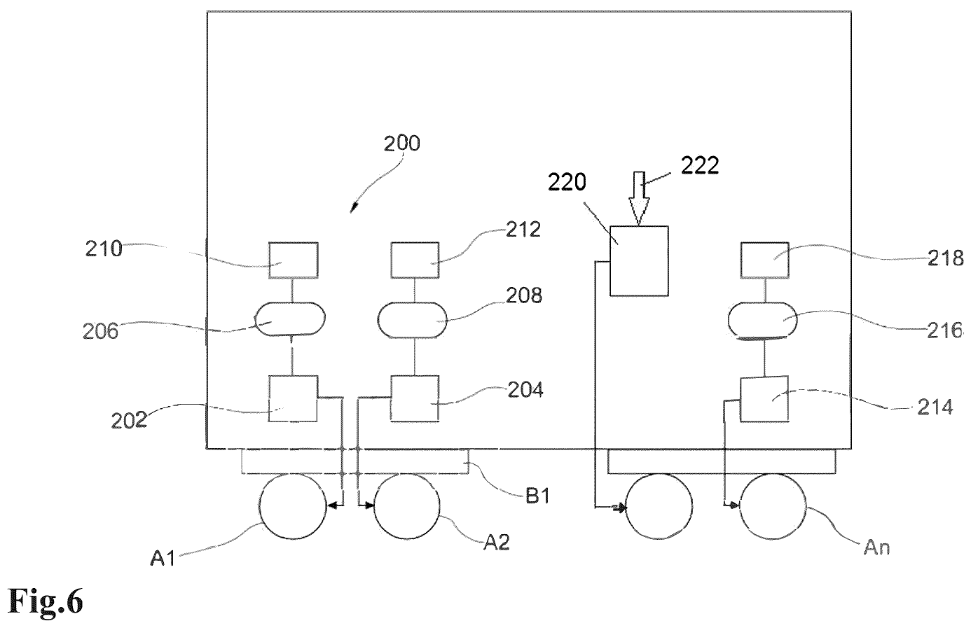

With reference to FIG. 6, in embodiments, a vehicle or a compressed air distribution system for a vehicle, e.g., as described relative to FIG. 2 herein, may additionally include an emergency braking system 220 onboard the vehicle configured to brake the vehicle responsive to a designated emergency braking signal 222. The emergency braking system may include, for example, one or more of an electrical control circuit, a pneumatic control device, braking cylinders, pressure valves, braking actuators like rods, callipers, etc., and/or one or more brake pads, brake shoes, or other friction members configured, when actuated, to press against one or more axles, wheels, or braking members (e.g., brake discs or brake drums) attached to axles or wheels. The emergency braking system may be configured to receive the braking signal 222 from an offboard source, such as a back office, a wayside device, a convoy control system onboard a locomotive or otherwise, and/or a convey brake pipe. Alternatively of additionally, the emergency braking system may be configured to autonomously generate the braking signal 222 based on and/or responsive to received information (e.g., sensor information) meeting designated criteria. In embodiments, the emergency braking system may utilize compressed air from the one or more reservoirs onboard the vehicle for carrying out emergency braking operations. In other embodiments, the emergency braking system may be additionally or alternatively configured to automatically initiate an emergency braking operation if pressure in the one or more onboard reservoirs falls below a designated level, and/or if another designated fault condition occurs.

In a further embodiment not illustrated in the figures, in the case of a group of vehicles connected to one another, a respective compressed air distribution system 500 may be installed on each vehicle. In other words, each vehicle may comprise: at least one respective air generation treatment unit, AGTU (also known as “Air Generation Treatment Unit”), configured to treat air solely intended for a braking system of the vehicle and/or at least one pneumatic system of the vehicle; a respective reservoir configured to contain compressed air to be supplied to the air generation treatment unit of the vehicle; and at least one compressor configured to generate compressed air to be stored in the respective reservoir of the vehicle.

In a further aspect, a rail vehicle or other vehicle includes at least a first wheel set A1 (having a first axle to which at least one first wheel is coupled), a second wheel set A2 (having a second axle to which at least one second wheel is coupled), a first braking system 202 configured to apply a braking force on the first wheel set A1, and a second braking system 204 configured to apply a braking force on the second wheel set A2. The vehicle also includes a compressed air distribution system 200 for a vehicle according to any one of the previous embodiments described for example with reference to FIGS. 2 and 3.

In another embodiment, a rail vehicle or other vehicle includes a first bogie B1 having a plurality of first wheel sets A1 (first axles to which respective wheels are coupled) and a second bogie B2 having a plurality of second wheel sets A2 (second axles to which respective wheels are coupled). The vehicle also includes a first braking system 402 configured to apply a braking force on the plurality of first wheel sets A1 of the first bogie B1, and a second braking system 404 configured to apply a braking force on the plurality of second wheel sets A2 of the second bogie B2. The vehicle further includes a compressed air distribution system 400 for a vehicle according to any one of the previous embodiments described for example with reference to FIG. 4.

In another embodiment, a rail vehicle or other vehicle includes at least an air generation treatment unit, and a compressed air distribution system 500 according to any one of the previous embodiments described for example with reference to FIG. 5.

In a further aspect, embodiments of the invention relate to a group of vehicles, particularly a rail vehicle convoy. The group of vehicles may include a plurality of vehicles according to any one of the embodiments described above. The vehicles of the group of vehicles are connected to one another. For example, the vehicles may be connected by means of couplers.

What has been described above for at least one vehicle, particularly a rail vehicle, can be similarly applied to a plurality of vehicles connected to one another to form a rail vehicle convoy or a group of interconnected vehicles.

As described above, aspects of the invention are applicable to at least one rail vehicle, travelling on railway tracks. For example, a vehicle according to the present disclosure may be a locomotive, and a route or part thereof may include rails on which the wheels of the locomotive roll. The embodiments described herein are not to be construed as limited to rail vehicles. For example, the vehicle may be a car, a truck (for example, a highway semi-trailer, a mining truck, a timber transport truck or the like), a motorcycle or the like, and the route may be a road or a path.

In embodiments, a rail vehicle or other vehicle as described herein (e.g., having a compressed air distribution system with two or more compressors and two or more reservoirs) is a single vehicle, i.e., the components of the compressed air distribution system are onboard one and only one vehicle. The single vehicle may lack a fuel engine. The single vehicle may also lack traction motors.

Compared to previous solutions which require the presence of a compressor having large size and high power, embodiments of the invention provide solutions having a distributed architecture which can be based on compressors provided with relatively lower power and lower weight compressors. In this way, it is possible to mitigate, or completely reduce, the drawbacks of existing systems as described above.

Aspects of the invention relates to the generation of compressed air of a vehicle, which allows to increase the utilisation rate of the compressor, reduce the vibrations and the noise generated overall with respect to the known systems for the generation of compressed air, while maintaining the filling capacity of the system unchanged or improving it.

Another aspect relates to the elimination of most or all of the pipes provided to convey the compressed air and the elimination of any pipe crossings between one vehicle and another, e.g., the proximity between the compressor and the reservoir, makes it possible to eliminate the pipes and to eliminate any pipe crossings between one vehicle and another.

Moreover, since there is no need for a very large-sized compressor, the market of “consumer” compressors is opened, with all the consequent economic advantages and availability of components. Moreover, since embodiments of the system include many compressors, the degree of reliability required of the individual compressor is reduced, since it is possible to guarantee the necessary performance and therefore the service even in degraded conditions.

Embodiments may be described in connection with a rail vehicle system, such as a locomotive or switcher, or other types of vehicle systems, such as automobiles, trucks (with or without trailers), buses, marine vessels, aircraft, unmanned aircraft (e.g., drones), mining vehicles, agricultural vehicles, or other off-highway vehicles. Vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers), or virtually or logically coupled but not mechanically coupled. For example, vehicles may be logically but not mechanically coupled when the separate vehicles communicate with each other to coordinate movements of the vehicles with each other so that the vehicles travel together (e.g., as a convoy, swarm, consist, platoon). Calculations and computations, such as navigation processes, may be performed on-board the vehicle systems or off-board the vehicle systems and then communicated to the vehicle systems. Whether on-board or off-board, a vehicle control system may operate a vehicle system and receive and process sensor inputs, operator inputs, operational parameters, vehicle parameters, and route parameters, etc.

Movement of a vehicle system may include propelling the vehicle forward or backward along a direction of travel, as well as slowing or stopping the vehicle. Movement further may include turning left or right and increasing or decreasing elevation or depth. Movement further may include determining or setting a vehicle speed, changing a vehicle speed, and matching speeds and directions between vehicles in a vehicle group. Indirectly, movement of the vehicle may include ramping up (or down) power sources; and this may include energizing electrical circuits or buses, setting fuel flow rates, setting engine RPM rates, and the like.

The terms “control circuit” and “controller” are substitutable with each other and encompasses hardwired circuitry, programmable logic (such as microprocessors, microcontrollers, digital signal processors (DSPs), programmable logic devices (PLDs), programmable gate arrays (PGAs), or field-programmable gate arrays (FPGAs)), state machines, or firmware that executes stored instructions. Control circuits may form part of larger systems, such as integrated circuits (ICs), application-specific integrated circuits (ASICs), or systems-on-chips (SoCs), and may be found in devices such as computers, smartphones, wearable devices, and servers. These circuits may perform tasks involving data processing, communication, or data storage. Depicted components, functions, or operations may be implemented using hardware, software, firmware, or combinations of two or more thereof.

Instructions for implementing system features may be stored in various types of memory. Suitable memory may include dynamic random-access memory (DRAM), flash memory, and/or cache. These instructions may be distributed over a network or via other computer-readable media. The term “non-transitory computer-readable medium” refers to any physical medium capable of storing or transmitting instructions or information that may be read by a machine. Examples of suitable media include RAM, ROM, EPROM, EEPROM, magnetic or optical media, flash memory, or even propagated signals such as carrier waves or infrared signals.

In one embodiment, data may be generated, transmitted, and stored and may involve one or both of a protected space data source and the exposed space data source. The control circuit may encrypt and decrypt data as needed at rest, during use, or in transit. Encryption keys and schema may be selected and implemented as informed by end use parameters and requirements. The control circuit may evaluate and/or identify a decision boundary (that is, a boundary that separates desired behavior from undesired behavior) with regard to that data. If the control circuit determines that some quantity of data is from a protected space data source and/or is operating within determined boundaries then the control circuit, and the equipment being controlled, may operate normally. However, if the data is determined to be from an exposed space data source and/or it crosses the decision boundary, the control circuit may respond. Suitable responses may be to power down determined equipment, signal an alert, run a diagnostic routine, perform a data backup (without overwriting existing backup data), isolate equipment (including by suspending some or all communication pathways), switch equipment or control operations to a safe mode of the control system, and/or initiate a safe mode state of the equipment (e.g., slow a vehicle to a safe and controlled stop). The safe mode may be, in one embodiment, a soft shutdown mode that it intended to avoid damage or injury based on the shutdown itself and in another embodiment may be a reboot and/or minimal reload of essential drivers and functionality.

In one embodiment, vehicle systems may implement secure authentication processes, encryption protocols, and firewalls to protect against unauthorized access or spoofing. A suitable control circuit may include a security module responsible for detecting and responding to suspicious activities, such as unapproved data access attempts or irregular communication patterns. This module may employ machine learning to adapt its defense strategies, learning from previous attacks and adjusting security measures as needed to prevent similar breaches.

Vehicle systems in various embodiments may use a combination of local and remote sensors to monitor environmental conditions, vehicle status, and external inputs. These sensors may detect parameters such as speed, acceleration, braking status, location, proximity to other objects or vehicles, ambient temperature, humidity, and lighting conditions. Raw data gathered by these sensors may feed into the control circuit, which in turn may respond to the input. The responses may include dynamically adjusting vehicle operations in response to real-time or near real-time changes in the environment or vehicle parameters; and processing the data for further analysis. In certain embodiments, sensors may utilize various types of communication protocols (e.g., Bluetooth, ZigBee, Wi-Fi, or cellular networks) to share data with control systems both within the vehicle and to external data processing centers.

In certain embodiments, maintenance and diagnostic functions may be integrated into the control circuit, enabling the system to self-monitor for operational health. The control circuit may utilize diagnostic algorithms to assess the status of various vehicle components, such as engines, brakes, batteries, fuel cells and fuel systems, propulsion systems, and electronic systems (if present). If a component is found to be underperforming or at risk of failure, the control circuit may schedule alerts, recommend maintenance, or initiate safety protocols to avoid catastrophic failure. Self-diagnostics may use historical performance data to identify trends, facilitating proactive rather than reactive maintenance.

Terms such as “processing,” “computing,” “calculating,” or “determining” refer to operations carried out by the control circuit, which may include computing systems or electronic devices that manipulate data represented as physical (electronic) quantities within memory or registers. One or more components may be described as “configured to,” “configurable to,” “operable/operative to,” “adapted/adaptable to,” or similar terms. Unless explicitly stated, these terms encompass components in both active and inactive states. Unless stated otherwise, terms like “including” or “having” should be interpreted as open-ended (e.g., “including but not limited to”). Numeric claim recitations generally mean “at least” the stated number, and disjunctive terms like “A or B” should be interpreted to include either or both unless explicitly specified. Operations in any claim may generally be performed in any order unless explicitly stated. The recitation “at least one of A, B, and C” should be interpreted as any combination of A, B, and C, such A alone, B alone, C alone, A and B together, A and C together, B and C together, and/or A, B, and C together. The recitation “at least one of A, B, or C” should be interpreted to include A alone, B alone, C alone, A and B together, A and C together, B and C together, and/or A, B, and C together.

This written description may disclose several embodiments of the subject matter, including the best mode and enablement to practice the embodiments of the disclosed subject matter, including making and using any devices or systems and performing any incorporated methods. The patentable scope of the subject matter is defined by the claims and may include other embodiments. Such other embodiments may be intended to be within the scope of the claims if they may have structural elements that may not differ from the literal language of the claims, or if they may include equivalent structural elements with insubstantial differences from the literal languages of the claims.

1. A compressed air distribution system for a vehicle, comprising:
a first reservoir configured to contain compressed air to be supplied to a first braking system of the vehicle, wherein the first braking system is configured to apply a first braking force to a first wheel set of the vehicle with the compressed air received from the first reservoir, the first wheel set including a first axle and at least one first wheel coupled to the first axle;
a second reservoir configured to contain compressed air to be supplied to a second braking system of the vehicle, wherein the second braking system is configured to apply a second braking force to a second wheel set with the compressed air received from the second reservoir, the second wheel set including a second axle and at least one second wheel coupled to the second axle;
a first compressor configured to generate compressed air to be stored in the first reservoir; and
a second compressor configured to generate compressed air to be stored in the second reservoir.

2. The compressed air distribution system of claim 1, wherein the first wheel set and the second wheel set are disposed in a first bogie of the vehicle.

3. The compressed air distribution system of claim 1, wherein the first wheel set is disposed in a first bogie of the vehicle and the second wheel set is disposed in a second bogie of the vehicle.

4. The compressed air distribution system of claim 1, further comprising:
one or more third reservoirs each configured to contain respective compressed air to be supplied to a respective one of one or more third braking systems of the vehicle each configured to apply a respective third braking force to a respective one of one or more third wheel sets of the vehicle with the compressed air received from the respective third reservoir, each of the one or more third wheel sets comprising a respective third axle and one or more respective third wheels coupled to the respective third axle; and
one or more third compressors each configured to generate compressed air to be stored in the respective one of the one or more third reservoirs.

5. The compressed air distribution system of claim 1, wherein the vehicle lacks any pneumatic lines for pneumatically connecting the vehicle to one or more adjacent vehicles to receive compressed air from the one or more adjacent vehicles for service braking.

6. The compressed air distribution system of claim 1, wherein the vehicle lacks any pneumatic lines for pneumatically connecting the vehicle to one or more adjacent vehicles to receive compressed air from the one or more adjacent vehicles, and further comprising an emergency braking system onboard the vehicle configured to brake the vehicle responsive to receipt of a designated emergency braking signal.

7. The compressed air distribution system of claim 1, wherein the vehicle is a single rail vehicle.

8. The compressed air distribution system of claim 1, further comprising:
at least one air generation treatment unit configured to treat air solely intended for at least one of the braking systems of the vehicle or at least one pneumatic system of the vehicle;
a third reservoir configured to contain compressed air to be supplied to the at least one air generation treatment unit; and
at least one third compressor configured to generate compressed air to be stored in the third reservoir.

9. A vehicle system comprising:
plural rail vehicles mechanically coupled to one another for travel along a track, each of the plural rial vehicles comprising a respective compressed air distribution system as recited in claim 1.

10. The vehicle system of claim 9, wherein the plural rail vehicles are not pneumatically coupled to one another, and each of the plural rail vehicles comprises a respective emergency braking system onboard the respective rail vehicle configured to brake the respective rail vehicle responsive to receipt of a designated emergency braking signal.

11. A vehicle comprising:
a first bogie comprising a plurality of first wheel sets, and a second bogie comprising a plurality of second wheel sets, each of the first and second wheel sets comprising a respective axle and one or more respective wheels coupled to respective axle;
a first braking system configured to apply a first braking force on the first wheel sets;
a second braking system configured to apply a second braking force on the second wheel sets; and
a compressed air distribution system comprising:
a first reservoir configured to contain compressed air to be supplied to the first braking system, wherein the first braking system is configured to apply the first braking force with the compressed air received from the first reservoir;
a second reservoir configured to contain compressed air to be supplied to the second braking system, wherein the second braking system is configured to apply the second braking force with the compressed air received from the second reservoir;
a first compressor configured to generate compressed air to be stored in the first reservoir; and
a second compressor configured to generate compressed air to be stored in the second reservoir.

12. The vehicle of claim 11, further comprising:
at least one further bogie each comprising a plurality of further wheel sets each having a respective further axle and one or more respective further wheels coupled to the respective further axle;
for each respective further bogie, a respective further braking system configured to apply a respective further braking force on the plurality of further wheel sets of the respective further bogie;
the compressed air distribution system further comprising, for each respective further bogie:
at least one respective further reservoir configured to contain compressed air to be supplied to the respective further braking system configured to apply the respective further braking force with the compressed air received from the at least one respective further reservoir; and
a respective further compressor configured to generate compressed air to be stored in the at least one respective further reservoir.

13. The vehicle of claim 11, wherein the vehicle lacks any pneumatic lines for pneumatically connecting the vehicle to one or more adjacent vehicles to receive compressed air from the one or more adjacent vehicles for service braking.

14. The vehicle of claim 11, wherein the vehicle lacks any pneumatic lines for pneumatically connecting the vehicle to one or more adjacent vehicles to receive compressed air from the one or more adjacent vehicles, and further comprising an emergency braking system onboard the vehicle configured to brake the vehicle responsive to receipt of a designated emergency braking signal.

15. The vehicle of claim 11, wherein the vehicle is a single rail vehicle.

16. The vehicle of claim 11, wherein the compressed air distribution system further comprises:
at least one air generation treatment unit configured to treat air solely intended for at least one of the braking systems of the vehicle or at least one pneumatic system of the vehicle;
a third reservoir configured to contain compressed air to be supplied to the at least one air generation treatment unit; and
at least one third compressor configured to generate compressed air to be stored in the third reservoir.

17. A compressed air distribution system for a vehicle, comprising:
at least one air generation treatment unit configured to treat air solely intended for at least one of a braking system of the vehicle or at least one pneumatic system of the vehicle;
a reservoir configured to contain compressed air to be supplied to the at least one air generation treatment unit of the vehicle; and
at least one first compressor configured to generate compressed air to be stored in the reservoir.

18. The compressed air distribution system of claim 17, further comprising at least a second compressor configured to generate compressed air to be stored in the reservoir.

19. The compressed air distribution system of claim 17, wherein the pneumatic system of the vehicle is at least one of:
an opening and closing system of at least one door of the vehicle;
a pneumatic suspension system of the vehicle;
a toilet system of the vehicle, or
a handling system of at least one pantograph of the vehicle.

20. The compressed air distribution system of claim 17, wherein the at least one air generation treatment unit comprises a plurality of air generation treatment units configured to treat air solely intended for the braking system of the vehicle and/or the at least one pneumatic system of the vehicle;
and wherein the reservoir is configured to contain compressed air to be supplied to the plurality of air generation treatment units of the vehicle.
